(19) United States
(12) Patent Application Publication
(10) Pub. No.: US 2013/0013460 A1
(43) Pub. Date: Jan. 10, 2013

(54) Virtual Concierge Search Assistant

(76) Inventor: Andrew J. Seligman, N. Potomac, MD (US)

(21) Appl. No.: 13/179,394

(22) Filed: Jul. 8, 2011

(51) Int. Cl. G06Q 30/00

(52) U.S. Cl. 705/27.1

(57) ABSTRACT

An enhanced search tool, equipped to perform advanced internet-based searches on a secured server computer, based on explicit and specific criteria provided by the user, fashioned to search a preferably e-retailer's specified website, or set of websites, for a service or commonly discontinued or out-of-stock product repetitively at a user-defined frequency until the specified product or service is found with the specific qualities required. Results are reported to the user via email or other electronic means. In the event that the performed searches do not return results within a user-defined period, the search may then automatically be refined by user-defined settings, adjusting to accommodate a broader range of products, enacted in subsequent search phases.

### FIELD OF THE PRESENT INVENTION

The present invention relates to an online service or product inventory search tool, designed to search a defined set of third-party websites for a product or service defined by the user. It is the intent of the present invention to provide a means by which consumers (users) may more effectively search for rare, discontinued, new, used, or out-of-stock products across a variety of e-retailer websites, configured to perform the search at user-defined intervals until the specified product or service is found, or until the search request expires at the time and date specified by the user. Results are conveyed to the user via conventional electronic means, and the search parameters may be automatically adjusted, based on user-defined criteria, according to the success rate of the initial search over time.

### BACKGROUND OF THE PRESENT INVENTION

At the dawn of the internet, data available to the masses was severely limited in comparison to modern standards. Connection speeds were low, and data packet sizes were small. Shopping was still primarily done at physical shopping malls and by mail-order catalog. Eventually, a decade or so later, e-retailer steadily began to emerge, which steadily brought the world of e-commerce to the forefront of the global economy. The inception of e-commerce brought a cornucopia of products and services to the hands of any internet-connected individual with a credit card or other confirmed payment option. The invention of PayPal™ helped foster the growth of the world of e-commerce, as individuals were able to purchase products more securely without substantial fear of fraud. More and more people use online e-commerce services today, given that it is generally a rapid way of finding what one is looking for in comparison to driving around and manually visiting stores in the physical world.

However, as the realm of e-commerce expands, as does the number of products and services that are presented online as available to the public. Technology has kept pace in stride for the most part, providing larger storage capacities and more efficient databases designed to keep track of product inventory and expedite shipping processes to ensure that the products reach the customers in the most efficient means possible. Search engines such as Google™ and Yahoo!™ have answered the call of managing to make information, products, and data itself more readily accessible to the general public through an easy-to-use search query system. However, even today, the searches performed by Google™ and other search engines are limited in scope with regards to e-commerce. This is primarily because Google™ is not e-commerce specific, and search results include all websites, not merely websites offering products or services for sale. Therefore, it doesn't automatically return solely the product an individual is searching for, but rather any and all information pertaining to the product, including its use, its construction, its repair, its history, etc. This can frequently make searching for a very specific product a fairly arduous task.

Thankfully, independent e-commerce sites have been outfitted with search parameters and micro-search engines, enabling visitors to the website to quickly find any product in inventory quickly and with relative ease. Search tags are generally cross-referenced against a database containing information including inventory count, product information, product reviews, product ratings, and much more. This system functions well when searches are pertaining to products in stock, currently still in inventory. Unfortunately, when searching for products that are discontinued, out of stock, or rare items, many intra-site search tools falter. As the products is either listed as perpetually ‘out-of-stock’ or ‘discontinued’ in the inventory database, the search engine will frequently return zero results, and only suggestions of similar products in an attempt to compensate for failing to return the desired product in the search. The visitor performing the search then must either give up his or her search for the elusive product, or perform additional searches at regular intervals into the future to determine if a match is eventually found. Given that each individual e-retailer website that has the potential to carry the target product must be searched individually manually by the consumer, it is easy to see how this process would rapidly become tedious and arduous rapidly for even the most patient consumer.

Due to the laborious nature of the process for searching for rare, discontinued, or elusive products across a variety of e-retailer websites, consumers often fail to find the desired product, and are forced to give up or to hire a specialist to find the item for a fee. Sites such as eBay™ and Amazon.com™ maintain highly sophisticated, integrated search engines designed to perform advanced searches for products across their database of both new and used items from a variety of sellers and sources. However, even their searches have the potential to return zero results in the event that no independent seller or e-retailer conscribed or included in their network of sources carries the desired product or has it in stock.

Thus, there is a need for an advanced search tool with the capacity to perform searches on an essentially infinite set of products, especially those designated as rare, out-of-production (discontinued), or consistently out-of-stock across a variety of user-defined websites, or a feature integrated into the existing intra-site search tool fashioned to provide consistent alerts to the consumer via email, text, or other conventional electronic means regarding the status of a preferably nearly perpetual search for the desired product performed at a frequency defined by the consumer.

U.S. Pub. No. 2006/0064333 for “Product Availability Tracking and Notification System and Method” by Razza et al., published on Mar. 23, 2006, shows a system and method “that automatically alerts consumers of product availability, such as air travel fares, that is automatically searched after an initial search is performed which meets the criteria of the user . . . . Notification of current pricing is display and communicated to the user once the product is available at a specified target price and after a predetermined time period if the defined target price is not found.” Unlike the present invention, Razza et al. is envisioned chiefly for air travel purchases.

U.S. Pat. No. 7,120,595 is for “Method and System for Providing Online Comparison Shopping” issued to Alexander on Oct. 10, 2006. Alexander's invention “includes the steps of compiling a shopping list identifying specific items to be purchased, receiving optimization criteria specified by the user, optimizing, by the system, the shopping list based on the optimization criteria to produce an optimal shopping order, and displaying the optimal shopping order to the user if the optimal shopping order exists.” Alexander is focused on providing online comparison shopping from among two or more vendors by compiling a shopping list of items, using optimization criteria to create an optimal shopping order, receiving the user's modifications to the optimal shopping order, etc.

Websites such as www.stuffalert.com and www.auctionsensor.com are available to users as web-based applications that provide alerts to users pertaining to a specific target item searched for by the user. However, these web-based application sites only function to return results from a single e-retailer, namely eBay. Additionally, these web-based applications employ substandard search protocols, which do not tend to provide the same effect or result sets as if a user manually typed search criteria into the text field on the e-retailer's homepage (www.ebay.com). Similarly, these sites do not function to search automatically at such frequent intervals, or for an infinite default duration, unlike the present invention. These web-applications are also fairly limited in scope, as they are not designed to automatically adapt and alter the search criteria or parameters with time, in order to slightly broaden the search in the event that the target is not found after a user-specified duration of time. This concept of search adaptation without additional user intervention beyond the initial search criteria is not an element of these web-applications. Preferably, a search tool is needed that may have user-defined, adaptive searches, enacted in subsequent search waves of phases in order to broaden the search, such as to permit ‘blue’ and ‘orange’ cars into the result set, aside from the initially targeted ‘red’ car.

### SUMMARY OF THE PRESENT INVENTION

The present invention relates to an online product or service inventory search tool, designed to search a defined set of third-party websites for a product or service defined by the user of the tool. A search is enacted by the service of the present invention in regimented intervals defined by the user, and is shaped by the search criteria, options, and limits of the search. The search preferably continues until the desired product or service is found, and the user is alerted by email or other conventional electronic means. The tool of the present invention is internet-based, and is preferably hosted by a secured server computer to provide a centralized location for the labor of the searches to be performed.

It is the intent of the present invention to perform advanced searches based on criteria provided by the user, and having the capabilities of drilling down into qualities of a product including, but not limited to, color, price, condition, age, and location. The present invention is, in essence, an online application, hosted on a secured server computer, and connected to the internet at a high speed. Given that the present invention is intended to be a web-based application, the instantiation of the form of the GUI and specific platform that the present invention is featured on will vary largely, and is designed to encompass embodiments including, but not limited to, a smartphone or iPhone™ application, a PC/Mac desktop application, a web-based application providing access to the tool of the present invention from a fixed web address (URL), or integrated directly into an appropriate variety of e-retailer's websites, especially pertaining to the checkout page of the e-retailer's web environment. For example, eBay™ could potentially find the present invention advantageous to their corporation, and choose to employ the present invention to enhance the searches performed by current users already frequently accessing their website, namely http::\\www.ebay.com™, and its subsidiaries and affiliates.

The search performed by the preferred embodiment of the present invention is fashioned to search a specified external or third-party website (ex: Buy.com™) defined by the user for a specific product, while providing the user an avenue to adequately define a product in-depth, such that qualities including price, color, and condition may be user-provided in the criteria, along with the item's description or keywords. Other options are available for certain searches. For example, when searching for a vehicle, options such as make, model, and year will preferably appear to enable the user to specify the vehicle's details further. The user performs this search via a conventional smartphone or computer platform, which sends a prompt to the computer server, which in turn contacts the inventory search servers hosted on the user's target e-retailer website. In the event that the target product is not listed in inventory on the specified target website, the present invention will perform continual searches for the product at a specified frequency for a user-specified duration, and providing regular updates to the user regarding the status of the searches via email or other conventional electronic delivery methods. After the user-defined duration has expired without returning acceptable results to the user, the present invention will begin to employ a secondary set or rules and criteria for the next phase of searches. This secondary set of rules is also user-defined, and is designed to be broader in scope, perhaps by expanding the number or colors that the user would find acceptable for the product, or expanding the price range. This process is fashioned to be automated based on the subsequent information from the user pertaining to secondary criteria for a secondary search, designed to broaden the scope of the initial search criteria. In this way, the user is never forced to return to an embodiment of the present invention to alter the search, and instead, may simply view all results and the status of each search via automated emails, texts, or other electronic message alerts. Still, searches may preferably be altered at any time from within any embodiment of the present invention if deemed necessary by the user.

### BRIEF DESCRIPTION OF THE DRAWINGS

FIG. 1 shows the preferred embodiment of the present invention as integrated into a mobile phone based application.

FIG. 2 displays an embodiment of the present invention as presented as a web application, accessible from any browser-equipped device.

FIG. 3 is a flow chart of the search process of the present invention.

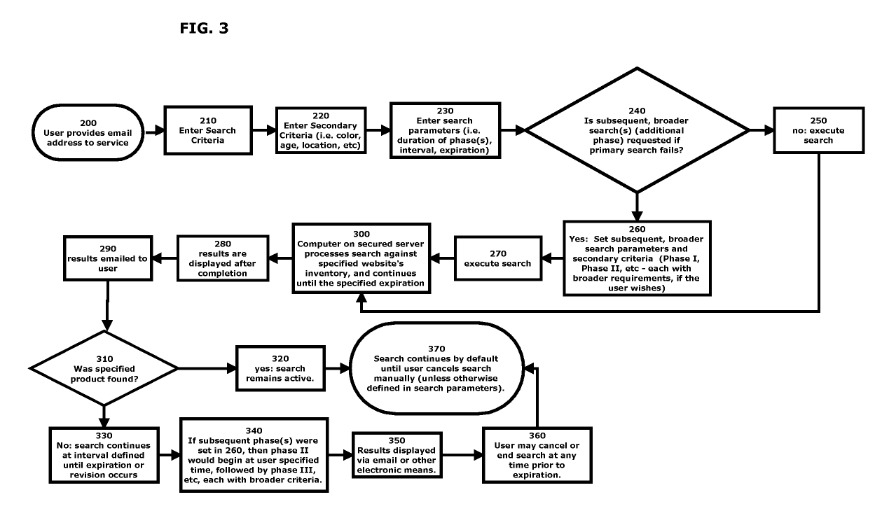

### DETAILED DESCRIPTION OF THE PREFERRED EMBODIMENT

The present invention, an advanced online service and product search tool, fashioned to function as an online application, hosted on a secured server computer, and connected to the internet in order to provide enhanced searches to users looking for specific products, especially those considered rare, used, or discontinued. It is the intent of the present invention to facilitate searches for products that often do not appear in conventional internet or product inventory searches. Individual searches are tagged to the searcher (known as user) via the user's unique email address, which also provides a direct means of delivery of the results of preferably each processed search. Searches are fashioned to be performed according to elaborate, user-defined criteria and parameters, including but not limited to, search duration (expiration date/time), search frequency or interval, and number of subsequent phases or broader search inquiries.

The process of the search inquiries is carried out by the secured server computer of the present invention, acting as a hub to route each search to the user-specified target website containing the inventory that is to be searched. The secured server is connected to the internet, providing a hosting point for the web application embodiment of the present invention, as well as a location to store a database housing the unique email addresses used to identify users and distinguish searches and users from one another. The hardware employed to provide the outlet for a user to request a search with the present invention is wide in scope, as the present invention could effectively be employed on nearly any internet connected device with limited internet browsing capabilities. This includes, but is not limited to, cellular telephones, tablet computers, desktop computers, netbook computers, television computers, and other electronic devices.

The search process performed by the present invention begins with a user requesting a search inquiry for a specific product or service housed in a user-defined, external e-retailer's website inventory database. The user first navigates to an instantiation of the present invention, either by opening an independent application on a smartphone or other internet connected device, or by navigating to the website hosting the web application embodiment of the present invention. The user is then prompted to provide an email address to the service (200), serving to identify the user, as well as to provide a medium of correspondence between the present invention and the user. Next the user is prompted to enter search criteria (210), which is generally limited to the product or service title only (ex: television). Following the primary criteria, the user is then prompted to enter secondary search criteria (220). Secondary search criteria is designed to enable the user to drill-down and specific more precisely the qualities of the target item or service. For example, if a user were searching for a specific car, the user would be able to enter the year, make, model, condition, mileage, color, price, and other options for the vehicle, narrowing the search to the exact product desired. It can be envisioned that the application embodiments of the present invention would include text boxes for criteria that were context sensitive, such that if a user began to type ‘car’ or ‘Honda’ when prompted to enter search criteria (210), that the secondary search criteria drop-down boxes would adapt to allow for further specification pertaining to vehicle features (such as make, model, mileage etc.). Therefore, if a user is searching for a vehicle, these options will appear, however, when searching for a television, options such as defining the mileage will not be available.

Following the initial outlining of the search target, the user is then prompted to enter search parameters (230) designed to define the duration and interval of the search. The duration of a search relates to the extent of time the user wishes the search to run automatically without interference. The search will continue until the designated expiration date or when the end of the timed duration (i.e. ‘45-minutes,’‘10 days,’ etc.) is reached as specified by the user. The default duration is preferably set to ‘infinite’, meaning the user must manually cancel the search in order for it to stop at all. Let it be made clear that a search will continue, by default, for an infinite period of time (370), even if a match or exact match is found. This feature is designed to provide the user with a means by which he or she may gauge the marketplace. A user will gather a more accurate representation of the market-price for the item or service searched for if the user has the opportunity to compare numerous matches to one another in the result sets. In this way, the present invention may be employed as a type of ‘research tool,’ fashioned to provide the user with a means of acquiring information pertaining to marketplace demand, availability, pricing, etc. This information can be critical for both researching potential purchases, as well as to gather information in the event a user plans to sell a product or service. Searches will be performed at regular intervals until the target is found. This interval is set by the user; however, the default interval is set to search preferably 1440 times per day, or once every minute. The user may also define how frequently the present invention is to send an automated email to the user, depicting the resulting matches, or lack of resulting matches.

After entering the search parameters (230), the user is then prompted to choose if he or she wishes to add subsequent search criteria for subsequent searches (also known as phases) that are broader in scope in the event that the primary search fails, or to decline (240). If the user opts to add additional phases, then the user is prompted to set subsequent, broader search parameters and secondary criteria (slightly broader for each phase—Phase I, Phase II, etc., if the user wishes) (260). The search is then executed for the first instance, sending a request to the secured server computer, which then queries the external inventory database of the requested, user-defined target website for the target (300). Results are then displayed after completion (280) to the user, and are subsequently emailed to the user (290) at the interval defined by the user. If the target is found, the search is concluded (320) after verification from the user. It can be envisioned that the user need not return to an embodiment of the present invention in order to verify the search's conclusion, or to conclude a search early; but that the user may implement basic commands such as ‘stop’ or ‘acceptable product found’ from within an automated email via an included hyperlink.

In the event that the search was not concluded, as an acceptable match for the target was not located yet, the search will continue at the interval defined by the user until expiration or revision, either by implementing a new phase, or directly by the user, occurs (330). If subsequent phases were set by the user when prompted, then phase II would begin at the user-specified time, followed by phase III, etc., each crafted with broader criteria, and ran in succession at the time(s) and date(s) selected by the user.

Supplemental search phases of the preferred embodiment of the present invention, as mentioned in 260, may be configured when prompted if the user elects to create them. Each phase would prompt the user with the same primary criteria and secondary criteria selection processes, but would request that the user provide slightly broader criteria for each incremental phase; otherwise, the likelihood for duplicate results remains high. For example: say a user is searching for a red, 1976 Pontiac Firebird. The first phase would be the requirements for the preferred ‘exact’ match. If the user is unwilling to waver or bend on any of the search requirements, no other phases are needed. However, if the user would also take a yellow Firebird, instead of the red, yet would still prefer the red, a supplemental phase (i.e., phase II) could be created to broaden the search to include yellow firebirds.

An additional embodiment envisioned for the present invention includes providing the service of the present invention to users online via an option housed within a traditional intra-site search. This embedded option would include a listing the links to run the search preferably based on the secured servers of the present invention, however when in cooperation with a third-party e-retailer, the search processes and labor may be performed on the third-party's server. To envision the present invention as embodied into an existing e-retailer's intra-site search system, envision a user searching for a target product and receiving no desirable matches. At the end of the unsuccessful search the present invention will prompt the user with the option to ‘continue searching into the future,’ whereupon the user will be permitted to create a custom search, preferably in a similar process to the one outlined above. It can be envisioned that an infinite number of subsequent search phases could be created by the user if the user so desires. Search data may be tracked on the secured-server of the present invention in order to return results sooner, as well as to provide data to advertising agencies to gauge product demand.

It can be envisioned that the present invention could be embodied into a conventional browser-integrated search toolbar. This could be done independently, as well as in conjunction with pre-existing search engine browser toolbars. Searches would function similarly to the web application embodiment search process, however, preferably after entering search criteria (210) into the toolbar search text field, and clicking search. This would preferably begin a preliminary search while other in-depth options to further customize the search, such as entering secondary search criteria (220) on a separate website returned by the secured-server.

Additionally, it is contemplated that an assortment of basic tasks may be accomplished by the user via hyperlinks found within the automated results emails sent by the secured server of the preferred embodiment of the present invention. These hyperlinks could enable the user to take actions regarding the requested search. These actions preferably include, but are not limited to, ending the search, beginning phase II early, or simply a link launching the web application. The user may elect to end the search prematurely from within the automated results email if the user finds the target product or service externally from the service of the present invention, and no longer wishes to receive email updates pertaining to the search.

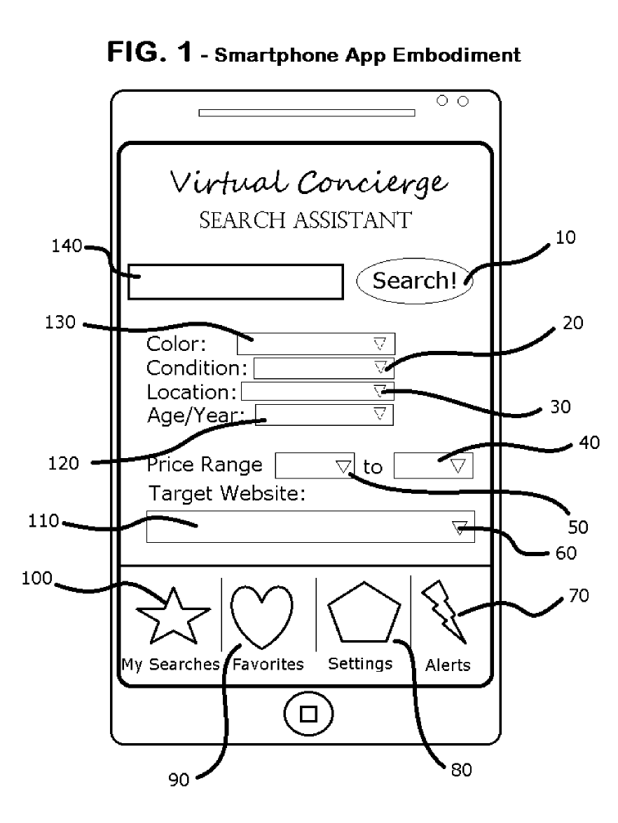

The preferred embodiment of the present invention as it exists as a smartphone application can be seen in FIG. 1. It exemplifies the streamlined user-interface preferably designed to facilitate the user's search for a specified target product or service across preferably any e-retailer's inventory. The user enters primary search criteria in the search text field (140), and then is prompted to provide secondary criteria, including color (130), condition (20), location (30)—such as ‘within 50 miles’ of a user-specified zip code, age or year (120), and price range. The price range secondary criteria provides two drop-down text fields which permit the user to enter a high end (40) price and a low end (50) for the present invention to use as a guide for item or service price.

It is envisioned that the secondary search criteria fields would be context sensitive to the primary search criteria initially entered for certain products. For example: if the user begins to search for a Pontiac Firebird, the advanced secondary criteria available to select by the user may include additional features pertaining specifically to vehicles including power windows, automatic transmission, four doors, etc. The smartphone app embodiment, as well as preferably any embodiment, includes a field known as the ‘target website select’ field (110). It preferably includes a conventional drop-down selection capability (60), enabling users to both hand-pick the e-retailer the user wishes to search the inventory of, as well as permitting them to enter a custom e-retailer's website manually with a text input device such as a keyboard or a conventional smartphone's virtual touch screen keyboard.

Additional options for searches can be accessed by the user using the links found at the bottom of the smartphone's screen while running the smartphone application of the preferred embodiment of the present invention. For example, a user may select the ‘my searches’ button (100), which will display a list of previous searches to the user, and provide him or her with the opportunity of editing the searches, checking their status, or simply executing them again. The ‘favorites’ button (90) can be used by the user to easily access searches or products that have been marked by the user as a ‘favorite.’

The ‘settings’ button (80) would preferably bring up a list of user-customizable default settings pertaining to searches and search reporting. For example, a user may wish to designate www.ebay.com as the default target website. Additionally, these settings would preferably include setting the interval of emails sent to the user listing results from searches, the default duration of a search, the email address the reports are to be sent to, as well as other settings.

The ‘alerts’ button (70) would provide the user with a page to outline the ways in which he or she wishes to be altered or informed about the results of each search interval and/or phase. It is envisioned that search alerts could be provided to alert the user immediately when the exact target product has been located. The user may configure the medium by which he or she is altered, be it via text message, automated voice mail message, email, or other electronic conventional means.

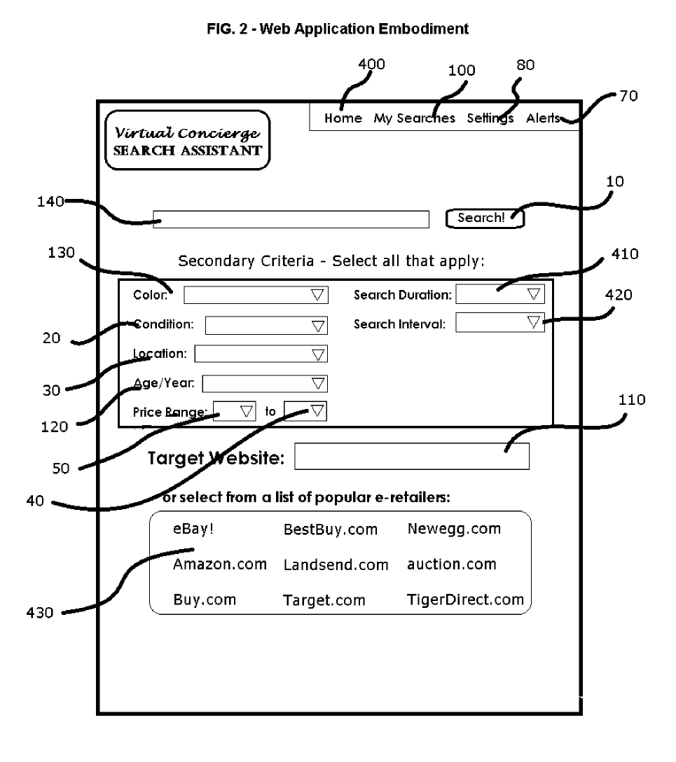

It is contemplated that the crucial selection of the ‘target website’ (110) of the search may be aided by the present invention generating a list of commonly-searched target websites (430), as seen in FIG. 2. This aides users in the selection or designation of the target website (110) for the desired search quickly, with minimal use of the keyboard.

It should be understood from all the above text that the present invention is a computer-driven online search method having a server computer providing a framework and GUI; the server computer performing a search of an external inventory database from a homepage of a target website; the server computer displaying a result set to a user; the server computer hosting a web based application; wherein said the server computer performing a search of an external inventory database from a homepage of a target website is the server computer executing a series of searches of a variety of websites for a user-specified query; wherein said the server computer performing a search of an external inventory database from a homepage of a target website, is the server computer performing subsequent searches for a target product at a frequency of 1400 per day for an infinite duration; wherein said the server computer performing a search of an external inventory database from a homepage of a target website is the server computer performing a search for a rare target product as defined by the user; wherein the server computer performing a search of an external inventory database has a used target product as defined by the user; wherein the server computer performing a search of an external inventory database has a discontinued target product as defined by the user; wherein the server computer performing a search of an external inventory database has an antique target product as defined by the user; wherein the server computer performing a search of an external inventory database is the computer server performing an identical search against different external inventory databases; wherein said the server computer displaying a result set to a user is the server computer displaying results from said the computer server performing and identical search against different external inventory databases; wherein said the server computer performing a search of an external inventory database from a homepage of a target website, is the server computer performing subsequent searches for a target product such that secondary criteria change in accordance with elapsed time; and wherein said the server computer performing a search of an external inventory database from a homepage of a target website, is the server computer performing subsequent searches for a target product such that secondary criteria change in accordance with preferences of the user.

I claim:

1. A computer-driven online search method, comprising:
a server computer providing a framework and GUI;
the server computer performing a search of an external inventory database from a homepage of a target website; and
the server computer displaying a result set to a user.

2. The computer-driven online search method of claim 1, further comprising:
the server computer hosting a web based application.

3. The computer-driven online search method of claim 1, wherein said the server computer performing a search of an external inventory database from a homepage of a target website is the server computer executing a series of searches of a variety of websites for a user-specified query.

4. The computer-driven online search method of claim 2, wherein said the server computer performing a search of an external inventory database from a homepage of a target website is the server computer executing a series of searches of a variety of websites for a user-specified query.

5. The computer-driven online search method of claim 1, wherein said the server computer performing a search of an external inventory database from a homepage of a target website, is the server computer performing subsequent searches for a target product at a frequency of 1400 per day for an infinite duration.

6. The computer-driven online search method of claim 1, wherein said the server computer performing a search of an external inventory database from a homepage of a target website is the server computer performing a search for a rare target product as defined by the user.

7. The computer-driven online search method of claim 1, wherein the server computer performing a search of an external inventory database has a used target product as defined by the user.

8. The computer-driven online search method of claim 1, wherein the server computer performing a search of an external inventory database has a discontinued target product as defined by the user.

9. The computer-driven online search method of claim 1, wherein the server computer performing a search of an external inventory database has an antique target product as defined by the user.

10. The computer-driven online search method of claim 1, wherein the server computer performing a search of an external inventory database is the computer server performing an identical search against different external inventory databases.

11. The computer-driven online search method of claim 10, wherein said the server computer displaying a result set to a user is the server computer displaying results from said the computer server performing and identical search against different external inventory databases.

12. The computer-driven online search method of claim 1, wherein said the server computer performing a search of an external inventory database from a homepage of a target website, is the server computer performing subsequent searches for a target product such that secondary criteria change in accordance with elapsed time.

13. The computer-driven online search method of claim 1, wherein said the server computer performing a search of an external inventory database from a homepage of a target website, is the server computer performing subsequent searches for a target product such that secondary criteria change in accordance with preferences of the user.

14. The computer-driven online search method of claim 12, wherein said the server computer performing a search of an external inventory database from a homepage of a target website, is the server computer performing subsequent searches for a target product such that secondary criteria change in accordance with preferences of the user.

15. A computer-driven online search method, comprising:
a server computer providing a framework and GUI;
the server computer performing a search of an external inventory database from a homepage of a target website;
the server computer displaying a result set to a user;
the server computer hosting a web based application;
wherein said the server computer performing a search of an external inventory database from a homepage of a target website is the server computer executing a series of searches of a variety of websites for a user-specified query;
wherein said the server computer performing a search of an external inventory database from a homepage of a target website, is the server computer performing subsequent searches for a target product at a frequency of 1400 per day for an infinite duration;
wherein said the server computer performing a search of an external inventory database from a homepage of a target website is the server computer performing a search for a rare target product as defined by the user;
wherein the server computer performing a search of an external inventory database has a used target product as defined by the user;
wherein the server computer performing a search of an external inventory database has a discontinued target product as defined by the user;
wherein the server computer performing a search of an external inventory database has an antique target product as defined by the user;
wherein the server computer performing a search of an external inventory database is the computer server performing an identical search against different external inventory databases;
wherein said the server computer displaying a result set to a user is the server computer displaying results from said the computer server performing and identical search against different external inventory databases;
wherein said the server computer performing a search of an external inventory database from a homepage of a target website, is the server computer performing subsequent searches for a target product such that secondary criteria change in accordance with elapsed time; and
wherein said the server computer performing a search of an external inventory database from a homepage of a target website, is the server computer performing subsequent searches for a target product such that secondary criteria change in accordance with preferences of the user.
